(19) United States
(12) Patent Application Publication
(10) Pub. No.: US 2018/0254631 A1
(43) Pub. Date: Sep. 6, 2018

(54) Power Receiving Unit For Charging While In Pre-Overvoltage Protection

(71) Applicant: QUALCOMM Incorporated, San Diego, CA (US)

(72) Inventors: Mark White, II, San Diego, CA (US); William Henry Von Novak, III, San Diego, CA (US); Chunlei Shi, San Diego, CA (US)

(21) Appl. No.: 15/451,173

(22) Filed: Mar. 6, 2017

(51) Int. Cl. H02H 9/04; H02J 50/12; H02J 7/02

(52) U.S. Cl. CPC H02H 9/042; H02J 7/025; H02J 50/12

(57) ABSTRACT

The present disclosure describes a power receiving unit for charging while in pre-overvoltage protection. In some aspects, reduced operation of an electronic implant device is initiated before resorting to overvoltage protection. In aspects, the electronic implant device has a power receiving unit capable of receiving power wirelessly from a wireless power transmitter. The power receiving unit can also detect an induced voltage and trigger pre-overvoltage protection when the detected voltage reaches a pre-overvoltage protection threshold. Additionally, a power management integrated circuit (PMIC) of the electronic implant device draws power from the power receiving unit to carry out corresponding functionality. The PMIC also obtains an indication when the detected voltage reaches the pre-overvoltage protection threshold. Based on the indication, the PMIC may reduce the power it draws from the power receiving unit to a predefined, reduced level instead of a normal operating level.

### FIELD OF THE DISCLOSURE

This disclosure relates generally to protecting components of a wireless power receiver of an implant in a body. More particularly, the disclosure relates to triggering reduced operation of the implant before triggering overvoltage protection.

### BACKGROUND

This description of related art is provided for the purpose of generally presenting a context for the disclosure that follows. Unless indicated otherwise herein, concepts described in this section are not prior art to this disclosure and are not admitted to be prior art by inclusion herein.

Biomedical implants are becoming more common for treatment of disease and medical conditions in humans as well as in animals. These implants can be inserted into a host's body for a variety of purposes, such as to release metered doses of medication, stimulate bodily tissue (e.g., nerves), monitor specific biochemical conditions, and so on. Oftentimes, such implants require electrical energy in order to operate—they need a power source, which typically takes the form of a chemical battery. Although implants are expected to be operative for several years (or a host's lifetime) without replacement, the chemical batteries used to power them may not be capable of operating that long. Thus, to keep these implants operating as designed, their batteries may need to be changed. Changing chemical batteries that are implanted can be difficult, however, and doing so can pose a significant risk to the host. Accordingly, such techniques for powering implants can put a host's life at risk

### SUMMARY

In some aspects of a power receiving unit for charging while in pre-overvoltage protection, reduced operation of an electronic implant device is initiated before resorting to overvoltage protection. In aspects, the electronic implant device has a power receiving unit capable of receiving power wirelessly from a wireless power transmitter. The power receiving unit can also detect an induced voltage and trigger pre-overvoltage protection when the detected voltage reaches a pre-overvoltage protection threshold. Additionally, a power management integrated circuit (PMIC) of the electronic implant device draws power from the power receiving unit to carry out corresponding functionality. The PMIC also obtains an indication when the detected voltage reaches the pre-overvoltage protection threshold. Based on the indication, the PMIC may reduce the power it draws from the power receiving unit to a predefined, reduced level instead of a normal operating level.

Some aspects of a power receiving unit for charging while in pre-overvoltage protection also involve a method in which alternating current (AC) power is received at a rectifier of a power receiving unit of an electronic device. The AC power is generated based on wireless power received at the power receiving unit from a wireless power transmitter. The method also includes rectifying the AC power to direct current (DC) power with the rectifier and supplying the DC power to power a load of the electronic device. Further, the method includes detecting that a rectified voltage of the DC power reaches a pre-overvoltage protection threshold. Responsive to this, overvoltage protection circuitry of the power receiving unit is triggered to cycle an overvoltage protection clamp and reduce an amount of DC power supplied to the load.

In other aspects, an apparatus includes implant specific circuitry to perform implant functions in a body. The apparatus also includes a power receiving unit. In aspects, the power receiving unit includes a power receiving coil configured to couple to a wireless field generated by a wireless power transmitter and receive wireless power. The power receiving unit also includes a rectifier configured to rectify AC power from the power receiving coil to DC power. Further, the power receiving unit includes an output terminal configured to output the DC power for operation of the implant-specific circuitry. In accordance with the described aspects, the power receiving unit also includes overvoltage protection circuitry disposed between the rectifier and the output terminal. The overvoltage protection circuitry is configured to detect that a rectified voltage of the DC power reaches a pre-overvoltage protection threshold and trigger pre-overvoltage protection responsive to detection.

In aspects, an apparatus for providing a power receiving unit for charging while in pre-overvoltage protection comprises a rectification means for rectifying AC power received to DC power. The apparatus also comprises an overvoltage protection clamping means for cyclically clamping the DC power so that a rectified voltage of the DC power oscillates between two defined overvoltage protection voltages—a first protection voltage level and a second release voltage level. In aspects, the overvoltage protection clamping means cyclically clamps the DC power responsive to the pre-overvoltage protection being triggered. Further, the apparatus includes a power management means for reducing the amount of DC power used by the apparatus during the cyclical clamping.

### BRIEF DESCRIPTION OF DRAWINGS

The details of various aspects are set forth in the accompanying figures and the detailed description that follows. In the figures, the left-most digit of a reference number identifies the figure in which the reference number first appears. The use of the same reference numbers in different instances in the description or the figures indicates like elements:

FIG. 1 illustrates an example environment that includes an implanted electronic device that utilizes a power receiving unit for charging while in pre-overvoltage protection.

FIG. 2 illustrates an example configuration of the power receiving unit shown in FIG. 1.

FIG. 3 illustrates an example diagram depicting indications of a rectified voltage, a rectified power, and an overvoltage control signal in a pre-overvoltage protection scenario.

FIG. 4 illustrates an example method for charging with a power receiving unit while in pre-overvoltage protection for an implanted electronic device.

FIG. 5 illustrates an example method for cycling overvoltage protection circuitry of a power receiving unit to provide pre-overvoltage protection and simultaneous charging for an implanted electronic device.

FIG. 6 illustrates an example method for configuring an implanted electronic device to provide a power receiving unit for charging while in pre-overvoltage protection.

FIG. 7 illustrates a system-on-chip (SoC) having components through which aspects of a power receiving unit for charging while in pre-overvoltage protection can be implemented.

FIG. 8 illustrates a wireless power transfer system having components through which aspects of a power receiving unit for charging while in pre-overvoltage protection can be implemented.

### DETAILED DESCRIPTION

Devices implanted in humans and animals are becoming more common, such as biomedical implants capable of treating disease and medical conditions. As used herein, a “host” refers to a respective body (e.g., human or animal) in which an implant is surgically inserted. Biomedical implants can be inserted into a host's body to provide a variety of biomedical functionality, such as to release metered doses of medication, stimulate bodily tissue (e.g., nerves), monitor specific biochemical conditions, and so on. Many implants (biomedical or otherwise) often require electrical energy in order to operate. In other words, these implants need a power source. Often the power source used to power an implant is a chemical battery. Broadly speaking, implants are capable of operating for several years (or a host's entire lifetime) without replacement. The chemical batteries used to power these implants, however, often are not capable of providing power that long. Thus, to keep an implant operating as designed, its battery may need to be surgically changed. The surgical procedures for changing implanted chemical batteries can be invasive and difficult to perform, however. Furthermore, doing so can pose a significant risk to the host. Accordingly, such techniques for powering implants can put a host's life at risk.

This disclosure describes aspects of a power receiving unit for charging while in pre-overvoltage protection. The apparatuses and methods described herein reduce operation of an implant charged with wirelessly received power before resorting to overvoltage protection. Overvoltage protection can involve simply disconnecting an implant's load (e.g., a battery or implant-specific components for carrying out the implant's corresponding function) from a power receiving unit. As a result, a power management integrated circuit (PMIC) that draws power from the power receiving unit for the load discontinues drawing power.

Disconnecting the load halts charging of the implant, however, which can result in a host of problems. When an implant's battery is dead, for instance, halting charging can cause communication with a wireless power transmitter to drop out, making system control difficult, if not impossible. This is because the wireless power transmitter may not receive an indication that overvoltage protection is applied and may thus continue transmitting power at a level that triggered overvoltage protection. Additionally, to resolve a dead battery condition power must continue to be provided to the battery, even small amounts for trickle charging. However, when the power receiving unit is in overvoltage protection, the battery may not be able to charge to a point where communication with the wireless power transmitter can be reestablished. These and other problems due to overvoltage protection may cause an implant to stop providing its functionality, which may be dangerous for the implant's host.

To overcome these problems, the described aspects reduce an implant's operation when an induced voltage reaches a level that is lower than the level for triggering overvoltage protection. By way of example, overvoltage protection may be triggered when the induced voltage at an implant's power receiving unit measures 20 volts. Before this, however, the described aspects may trigger reduced operation, such as when the induced voltage at an implant's power receiving unit measures 17 volts. This threshold and the actions taken to reduce operation to prevent the induced voltage from reaching the overvoltage protection threshold may be referred to using “pre-overvoltage protection.” The example 17-volt threshold may be referred to as a “pre-overvoltage protection threshold,” for instance. In any case, the threshold for pre-overvoltage protection corresponds to a lower voltage than the threshold for overvoltage protection.

In pre-overvoltage protection, an overvoltage protection clamp of the implant is triggered and the PMIC of the implant reduces a level of power it draws from the implant's power receiving unit, e.g., the level of power is reduced from an amount drawn during normal operation. Thus, rather than continue to draw power at a normal-operation level, the PMIC is configured to draw power from the power receiving unit at the reduced level. This can prevent a voltage at the power receiving unit from collapsing too quickly for the system to recover—a quick collapse may cause disconnection of the PMIC from the power receiving unit and halted charging of the implant.

To implement pre-overvoltage protection, detection of a pre-overvoltage condition (e.g., reaching the threshold voltage) can be communicated to the PMIC by the power receiving unit, as described in more detail below. Based on the communication, the PMIC reduces its power demand to the reduced level, which may correspond to a predetermined power level considered safe for overvoltage protection. In one or more aspects, this predetermined level may be programmed into the PMIC as part of system design. In particular, the predetermined level corresponds to a level where power can be provided to a battery without collapsing the voltage at the power receiving unit while an overvoltage protection clamp of the power receiving unit is engaged. Instead of collapsing the voltage by fully engaging this overvoltage protection clamp, the clamp may be cyclically engaged so that the voltage oscillates between a defined overvoltage protection hysteresis, e.g., controlled by a Schmitt trigger as described below. Since the power draw from the PMIC is reduced while the clamp is engaged, the rectified voltage at the power receiving unit is prevented from collapsing. This also allows power delivered to the implant's circuitry for carrying out its corresponding functionality to remain substantially constant.

By leveraging pre-overvoltage protection, implants may still be able to communicate with wireless power transmitters, e.g., to indicate that pre-overvoltage protection has been triggered. Pre-overvoltage protection also allows the batteries of implants to at least trickle charge. Further, this may allow wireless power transmitters to transmit power using a continued, aggressive (higher) H-field magnitude, rather than use a conservative (lower) H-field magnitude. In an environment where multiple implants use a same transmitter, this allows an implant with lower coupling to trickle charge without forcing other implants with higher coupling into full overvoltage protection.

These and other aspects of a power receiving unit for charging while in pre-overvoltage protection are described below in the context of an example environment, example circuitry of a power receiving unit, and techniques. Any reference made with respect to the example environment or power receiving unit circuitry, or elements thereof, is by way of example only and is not intended to limit any of the aspects described herein.

### Example Environment

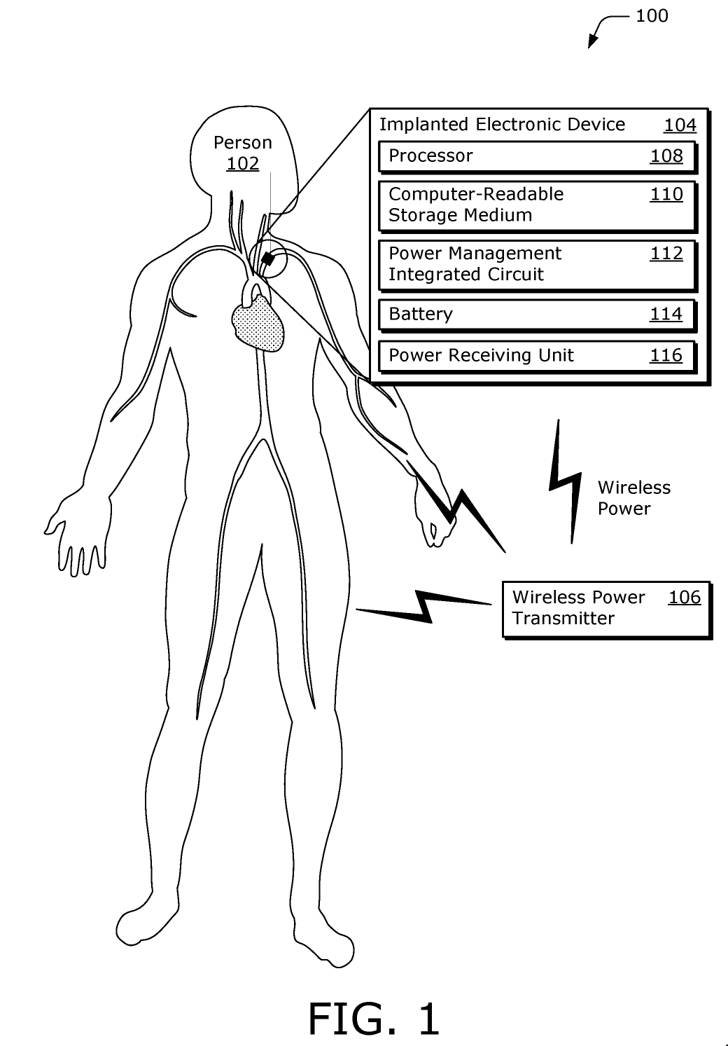

FIG. 1 illustrates an example environment 100, which includes a person 102 in which an implanted electronic device 104 has been surgically implanted. The example environment also includes a wireless power transmitter 106, which is configured to supply power wirelessly to the implanted electronic device 104. The implanted electronic device 104 may be implemented as any suitable computing or electronic device that is implanted in the person 102 and capable of being powered with the wireless power transmitted by the wireless power transmitter 106. Examples of the implanted electronic device 104 include implants to release metered doses of medication, implants to stimulate bodily tissue (e.g., nerves), implants for managing reproduction, implants to monitor specific biochemical conditions, and so on. Electronic devices other than medical-based implants may also be contemplated within the techniques described herein, such as personal communication devices, identification devices, location tracking devices, and so forth. Accordingly, the implanted electronic device 104 may correspond to a variety of different implanted computing or electronic devices without departing from the spirit or scope of the techniques described herein.

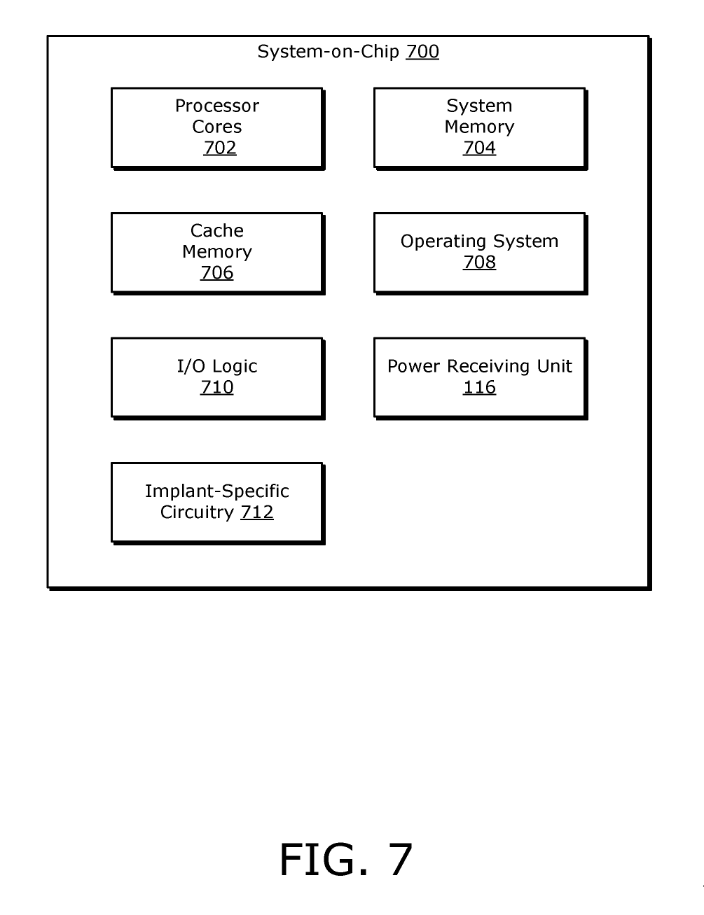

The implanted electronic device 104 includes a processor 108. In the example, the implanted electronic device 104 also includes computer-readable storage medium 110 (CRM 110). The processor 108 may include any type of processor, such as an application processor or multi-core processor, configured to execute processor-executable code stored by the CRM 110. The CRM 110 may include any suitable type of data storage media, such as volatile memory (e.g., random access memory (RAM)), non-volatile memory (e.g., Flash memory), optical media, magnetic media (e.g., disk or tape), and the like. In the context of this disclosure, the CRM 110 is implemented to store instructions, data, and other information of the implanted electronic device 104, and thus does not include transitory propagating signals or carrier waves. Further, although the implanted electronic device 104 is illustrated with the CRM 110, in some aspects the implanted electronic device 104 may instead or additionally be implemented using a system-on-chip (SoC) as further described in relation to FIG. 7.

Although not depicted in the example, the implanted electronic device 104 may also include data interfaces to provide connectivity to respective networks and other electronic devices connected therewith. Such data interfaces may include wired, wireless, or a combination of data interfaces. Wired data interfaces can be usable to connect with the implanted electronic device 104 before it is implanted into a body, during a surgical procedure in which the implanted electronic device 104 is exposed, when the implanted electronic device 104 has been removed from the body, and so on. Wireless data interfaces may include a modem or radio configured to communicate over a wireless network, such as a wireless LAN, peer-to-peer (P2P), cellular network, and/or wireless personal-area-network (WPAN).

The implanted electronic device 104 also includes power management integrated circuit 112 (PMIC 112), battery 114, and power receiving unit 116. The PMIC 112 is capable of managing power for the implanted electronic device 104, including managing electrical power conversion and power control functions. In conjunction with the power receiving unit 116, the PMIC 112 may manage the power received by the implanted electronic device 104 via the power receiving unit 116. By way of example, the PMIC 112 may be capable of reducing a power draw for charging the battery 114 or for operating implant-specific circuitry of the implanted electronic device 104 used to carry out its corresponding functionality.

The battery 114 represents functionality to store power received via the power receiving unit 116 for later use. In some aspects, the power received by the power receiving unit 116 may be fed to the battery 114, and the implanted electronic device 104 may draw power for operation from the battery 114. In other aspects, the implanted electronic device 104 may draw power for operation directly from the power receiving unit 116 and rely on the battery 114 solely when the power received directly from the power receiving unit 116 is not enough to function properly. In both cases, the implanted electronic device 104 may be configured to use power stored in the battery 114 for operation.

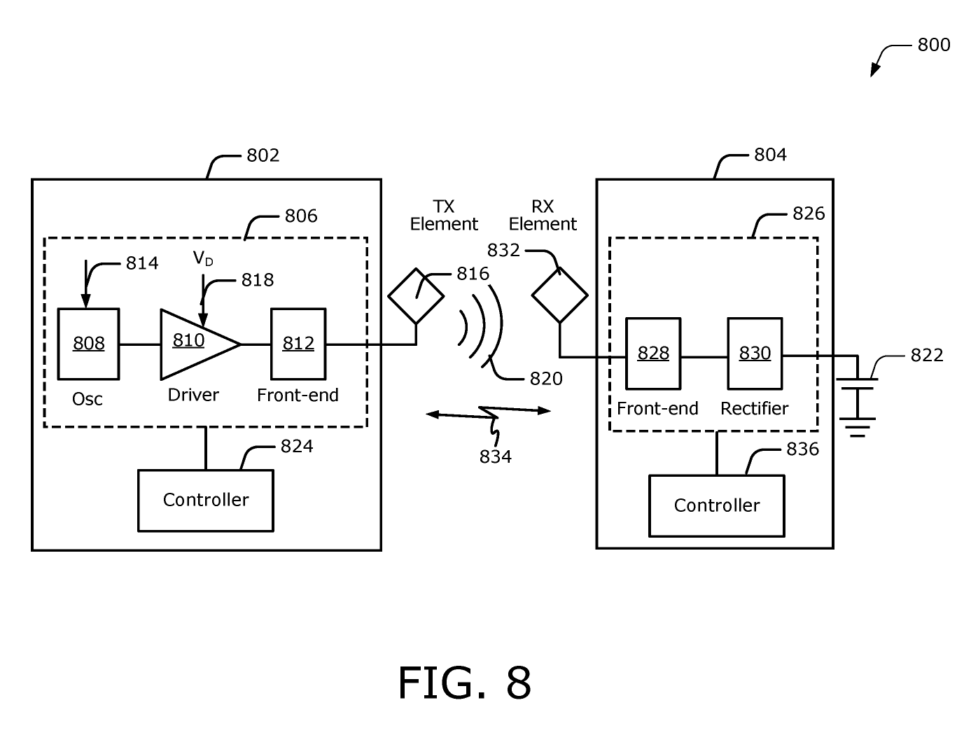

Broadly speaking, the power receiving unit 116 represents functionality of the implanted electronic device 104 to receive power wirelessly from the wireless power transmitter 106. The power receiving unit 116 may be configured in accordance with the wireless power transfer system discussed in relation to FIG. 8. In one or more aspects, the power receiving unit 116 may include a resonator configured to resonate when exposed to electromagnetic fields or magnetic fields having a certain frequency or certain frequencies, including electromagnetic or magnetic fields produced by the wireless power transmitter 106.

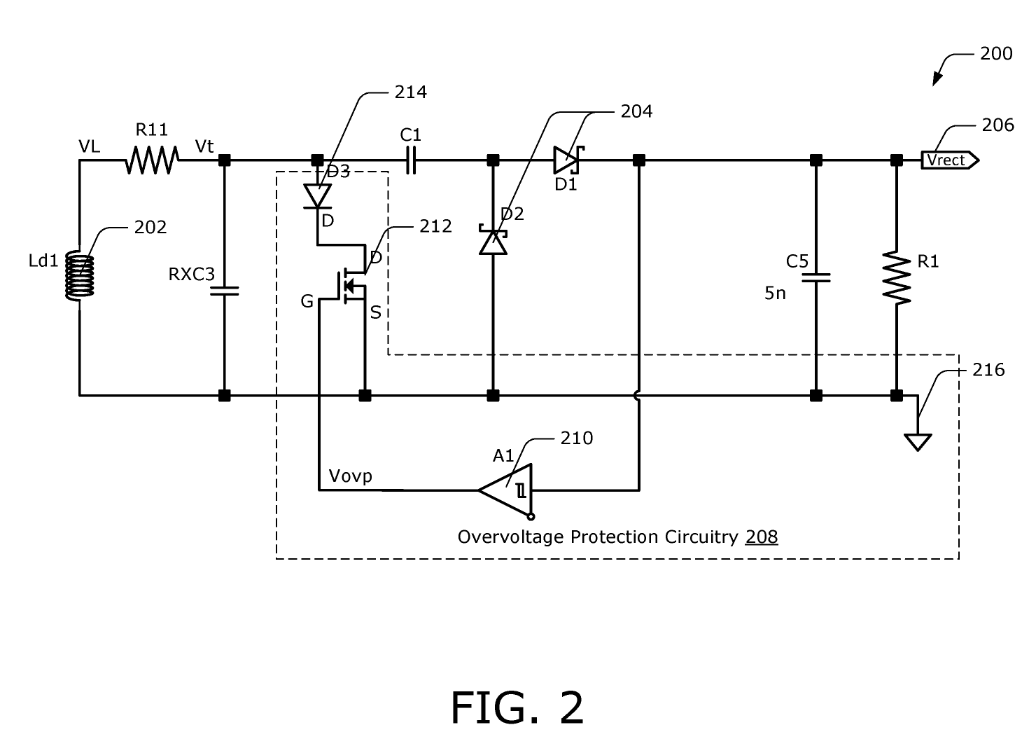

Accordingly, the wireless power transmitter 106 may be configured to generate electromagnetic or magnetic fields having a certain frequency and a receiving coil of the power receiving unit 116 configured to couple to electromagnetic or magnetic fields with that frequency. The power receiving unit 116 may couple to these fields to receive power wirelessly from the wireless power transmitter. In accordance with the described aspects, the power receiving unit 116 may be configured with rectification and overvoltage protection circuitry, as depicted in FIG. 2. The rectification circuitry is capable of converting the power produced at the receiving coil into a form that is usable by the implanted electronic device 104. This may involve rectifying the power from alternating current (AC) to direct current (DC), lowering a voltage, and so on.

The overvoltage protection circuitry ensures that the components of the implanted electronic device 104 used to carry out its functionality receive power in a form for which they are designed. This prevents those components from becoming stressed beyond their designed operating capabilities and breaking—causing the implant to fail, or worse injuring the person 102. To do so, the overvoltage protection circuitry may cut off power when the induced voltage at the power receiving unit 116 reaches a predefined level and engage an overvoltage protection clamp. For example, the overvoltage protection circuitry may include a switch to short the power receiving unit 116 to ground, which may cause the induced voltage to drop to zero. By cutting off the power when a certain voltage is induced, the overvoltage protection circuitry provides “overvoltage protection” for the components of the implanted electronic device 104. This prevents damage to the power receiving unit 116 as well as other components of the implanted electronic device 104, e.g., the PMIC 112, implant-specific circuitry, and so forth.

In connection with cutting off power and engaging the overvoltage protection clamp in this way, the load (e.g., the battery 114 and/or power receiver system such as the implant-specific circuitry) may also be disconnected from the power receiving unit 116, such that the load does not receive power. Though overvoltage protection is effective to protect the implant's circuitry, overvoltage protection can also cause a host of problems as described above, such as those that result from disabling communication with the wireless power transmitter 106. Thus, in addition to configuring the overvoltage protection circuitry to trigger full overvoltage protection (e.g., completely cutting off power), the described aspects also involve configuring the overvoltage protection circuitry to trigger pre-overvoltage protection. Generally, pre-overvoltage protection involves taking one or more measures intended to prevent the overvoltage protection threshold from being reached, and is triggered at a voltage level below the overvoltage protection threshold.

In accordance with one or more aspects, the PMIC 112 is configured to reduce the power it draws from the power receiving unit 116 as part of pre-overvoltage protection. Additionally, overvoltage protection circuitry of the power receiving unit 116 may cycle an overvoltage protection measure (such as by shorting the power receiving unit 116 to ground), rather than simply dropping power. By way of example, the power receiving unit 116 may include an overvoltage protection clamp that it cycles on and off with hysteresis. By utilizing pre-overvoltage protection, the implanted electronic device 104 may be allowed to continue charging (though at a reduced level), while also preventing a voltage of the power receiving unit 116 from reaching unsafe levels. Pre-overvoltage protection may involve a variety of different and/or additional measures without departing from the spirit or scope of the techniques described herein, such as communicating with the wireless power transmitter 106 to indicate that pre-overvoltage protection has been triggered.

How a power receiving unit 116 may be specifically implemented to provide charging while in pre-overvoltage protection is described in more detail below.

### Example Power Receiving Units

FIG. 2 illustrates an example configuration of the power receiving unit 116 from FIG. 1 in accordance with one or more aspects at 200. In particular, the example configuration includes receiving coil 202, rectifier 204, and output terminal 206 as well as overvoltage protection circuitry 208, which in this example includes a Schmitt trigger 210, N-channel metal-oxide semiconductor field-effect transistor (MOSFET) 212 (NMOS transistor 212), diode 214, and ground terminal 216. The example configuration also includes a variety of other components for tuning power received wirelessly by the receiving coil and for tuning the rectified voltage (Vrect). By way of example, the configuration is also depicted with a resistor and capacitor coupled to the receiving coil 202, capacitors coupled to diodes of the rectifier, and a resistor coupled to the output terminal 206 and the ground terminal 216. The power receiving unit may include more, fewer, or simply different components than those depicted without departing from the spirit or scope of the described aspects.

Broadly speaking, the receiving coil 202 is configured to couple to a wireless field generated by the wireless power transmitter 106 effective to produce current at the power receiving unit 116 that can be leveraged to power the implanted electronic device 104. In particular, in an implementation that relies on resonance, the receiving coil 202 is configured as a resonator that resonates when exposed to a wireless field having a certain frequency or frequencies that are within a range of frequencies for which the resonator is designed. Further, the wireless field causes flow of an alternating current (AC) at the receiving circuitry that includes the receiving coil 202.

The rectifier 204 of the example configuration is configured to rectify the AC power from the receiving circuitry to direct current (DC) power. The DC power generated by the rectifier 204 can be output via the output terminal 206, such as to the PMIC 112 where it is ultimately used to charge the battery 114 and/or used by implant-specific circuitry to carry out the implanted electronic device 104's corresponding functionality. Additionally, the output terminal 206 is labeled with “Vrect” to indicate a rectified voltage at the output terminal 206.

The output terminal 206 is capable of outputting power that is conditioned for use by the implanted electronic device 104. In particular, the power output at the output terminal 206 meets operating specifications for other functional components of the implanted electronic device 104. To the extent that the example rectification circuit includes the rectifier 204 and the overvoltage protection circuitry 208, the power output by the output terminal 206 is at least rectified from AC to DC and clamped at the pre-overvoltage protection level for which the overvoltage protection circuitry 208 is designed.

As discussed above and below, the overvoltage protection circuitry 208 is configured to engage an overvoltage protection clamp. In connection with pre-overvoltage protection, the overvoltage protection circuitry 208 is configured to cycle the overvoltage protection clamp on and off with hysteresis. In particular, the overvoltage protection circuitry 208 may be configured to trigger the cycling when the rectified voltage from the rectifier 204 reaches a pre-overvoltage protection threshold. In one or more aspects, this involves asserting and de-asserting an overvoltage protection signal (Vovp in FIG. 2), such that when the overvoltage protection signal is asserted the clamp is engaged and when the overvoltage protection signal is de-asserted the claim is disengaged.

In the illustrated example, the Schmitt trigger 210 is capable of asserting the overvoltage protection signal as a drive signal with voltage sufficient to activate the NMOS transistor 212. When the rectified voltage reaches the pre-overvoltage protection threshold, for example, the Schmitt trigger 210 is configured to produce the drive signal, which is applied to the gate of the NMOS transistor 212. Based on application of this signal, the NMOS transistor 212 allows at least some current to flow between its drain and source to short the power receiving unit 116 to the ground terminal 216—rather than continue flowing to the rectifier 204. This is configured to cause the rectified voltage to drop. Unlike full overvoltage protection, however, the rectified voltage is not allowed to collapse to zero volts in pre-overvoltage protection.

Instead, when the rectified voltage drops to a predefined lower threshold level, the Schmitt trigger 210 is configured to de-assert the overvoltage protection signal implemented as the drive signal. With the drive signal de-asserted, the NMOS transistor 212 ceases current flow between its gate and source, such that current in the power receiving unit 116 is no longer shorted to the ground terminal 216. As a result, however, the rectified voltage may again increase, e.g., up to the pre-overvoltage protection threshold. When this happens, the Schmitt trigger 210 again produces the drive signal and the NMOS transistor 212 allows current to flow between its drain and source to short the power receiving unit 116 to the ground terminal 216. The Schmitt trigger 210 may thus cause the overvoltage protection circuitry 208 to be cyclically engaged and disengaged in this manner.

In aspects, the hysteresis, between which the rectified voltage is allowed to oscillate during pre-overvoltage protection, may be defined by voltage thresholds programmed into the Schmitt trigger 210. For example, the Schmitt trigger 210 may be programmed to produce the drive signal when an input voltage corresponds to the pre-overvoltage protection threshold. The Schmitt trigger 210 may also be programmed to cease producing the drive signal once the input voltage corresponds to a lower, predetermined level, e.g., a level considered safe for resuming operation of the power receiving unit 116 and other circuitry of the implanted electronic device 104. Although the power receiving unit 116 is shown implemented with an NMOS transistor or active high circuits, the aspects described herein may also be implemented using complimentary silicon devices (e.g., p-channel MOSFET transistors (PMOS transistors)) or active low circuits. The power receiving unit 116 may be configured with different circuitry than depicted in the example configuration to cycle overvoltage protection on and off without departing from the spirit or scope of the techniques described herein.

In addition to cyclically engaging an overvoltage protection clamp of the power receiving unit 116, the described aspects also involve reducing power drawn by the PMIC 112. In scenarios where a PMIC does not adjust the power drawn from the power receiving unit 116, the voltage induced on the power receiving unit 116 when the overvoltage protection clamp is engaged may collapse too quickly for the system to re-enable the receiver and thus begin to increase the voltage. By reducing the power draw in response to reaching the pre-overvoltage protection threshold though, the voltage induced on the power receiving unit 116 may collapse less quickly than with a normal-operating power draw, providing sufficient time for the rectified voltage to recover and increase once the overvoltage protection clamp is de-asserted. Accordingly, when it is detected that the voltage induced on the power receiving unit 116 reaches the pre-overvoltage protection threshold, an indication of this condition is communicated to the PMIC 112. The indication that the pre-overvoltage protection threshold is reached can be communicated to and obtained by the PMIC 112 in a variety of different ways. By way of example, the indication can be communicated via a pin shared with the power receiving unit 116, using inter-integrated circuit (I2C) protocol, according to system power management interface (SPMI) specification, or using direct voltage sensing. The PMIC 112 may be notified that the pre-overvoltage protection threshold has been reached in a variety of other ways without departing from the spirit or scope of the techniques described herein.

Based on the communication, the PMIC 112 is configured to reduce its power demand to a predetermined level that is determined safe for overvoltage protection. This predetermined level may be preprogrammed into the PMIC 112 as part of system design, and corresponds to a level where power can be sent to the battery 114 or implant-specific circuitry without collapsing the voltage induced on the power receiving unit 116. Instead of collapsing the voltage, this allows the voltage to oscillate between the defined overvoltage protection control hysteresis, e.g., as defined by the Schmitt trigger 210. This also allows the power that is delivered to the load to remain substantially constant, e.g., for trickle charging or communication. In other words, pre-overvoltage protection enables the power receiving unit 116 and the PMIC 112 to continue operation during otherwise unsafe conditions by providing an opportunity to negotiate an alternative operating point, e.g., negotiate to cause the PMIC 112 to draw less power than the normal-operating power draw. In this way, the system can operate at the reduced operating point rather than immediately shutting down or resetting power transfer.

Another advantage of continuing to deliver substantially constant power, even at a reduced level from normal operation, is that it allows the power receiving unit 116 to continue communicating with the wireless power transmitter 106. Consider an example in which the voltage at a power receiving unit of one implant in a host's body is prioritized or optimized—triggering pre-overvoltage protection for the power receiving units of other implants in the host's body. By enabling continued communication, the described techniques allow the other power receiving units in pre-overvoltage protection to keep charging so treatments can continue being administered. Additionally, pre-overvoltage protection allows the power receiving unit 116 to boot up and communicate in the presence of an otherwise acceptably high voltage, e.g., communicate to the wireless power transmitter 106 to adjust the voltage. Accordingly, the wireless power transmitter 106 may adjust the operating point based on the communication.

The power receiving unit 116 may communicate with the wireless power transmitter 106 in a variety of different ways, including using in-band and out-of-band communication. In-band communication techniques may utilize the receiving coil 202 of the power receiving unit 116 to communicate different signals to the wireless power transmitter 106, such as signals indicating that the pre-overvoltage protection threshold has been reached, indicating a measured voltage at the power receiving unit 116, a level at which power is drawn by the PMIC 112, and so on. Out-of-band communication techniques may utilize communication-dedicated hardware, such as a modem or radio with which the implanted electronic device 104 is configured to communicate over a wireless personal-area-network (WPAN). Out-of-band communication techniques may correspond to different frequencies (or a different frequency band) than the wireless power transmitted by the wireless power transmitter 106.

In some aspects, communications between the implanted electronic device 104 and the wireless power transmitter 106 regarding detected overvoltage protection conditions and pre-overvoltage protection conditions may be configured according to a communication standard for implants and wireless power transmitters. Such a standard may specify a format of communications, for instance, such as specifying that a communication indicating an overvoltage protection condition or pre-overvoltage protection condition include a measured voltage at a power receiving unit. Alternately or in addition, the standard may specify how implants are to detect and handle overvoltage and pre-overvoltage protection conditions, how a wireless power transmitter is to respond when notified of these conditions, and so forth. By utilizing a standard, implants developed by different implant providers may predictably handle detected overvoltage and pre-overvoltage protection conditions. Further, this may allow multiple implants developed by different providers to be surgically implanted into a body and powered by a single wireless power transmitter. The wireless power transmitter may be configured to handle overvoltage and pre-overvoltage protection conditions detected in a single one of the multiple implanted devices according to the standard.

In addition to the above-discussed advantages, pre-overvoltage protection also increases a range of induced voltages a power-transfer ecosystem can handle. In general, once an ecosystem is established, there is an approximate range of voltage that newly introduced power receiving units must accommodate in order to also be incorporated into the ecosystem. By configuring power receiving units to utilize pre-overvoltage protection, however, the power receiving unit operational induced voltage range may be increased. This makes power-receiving-unit design easier and faster for developers.

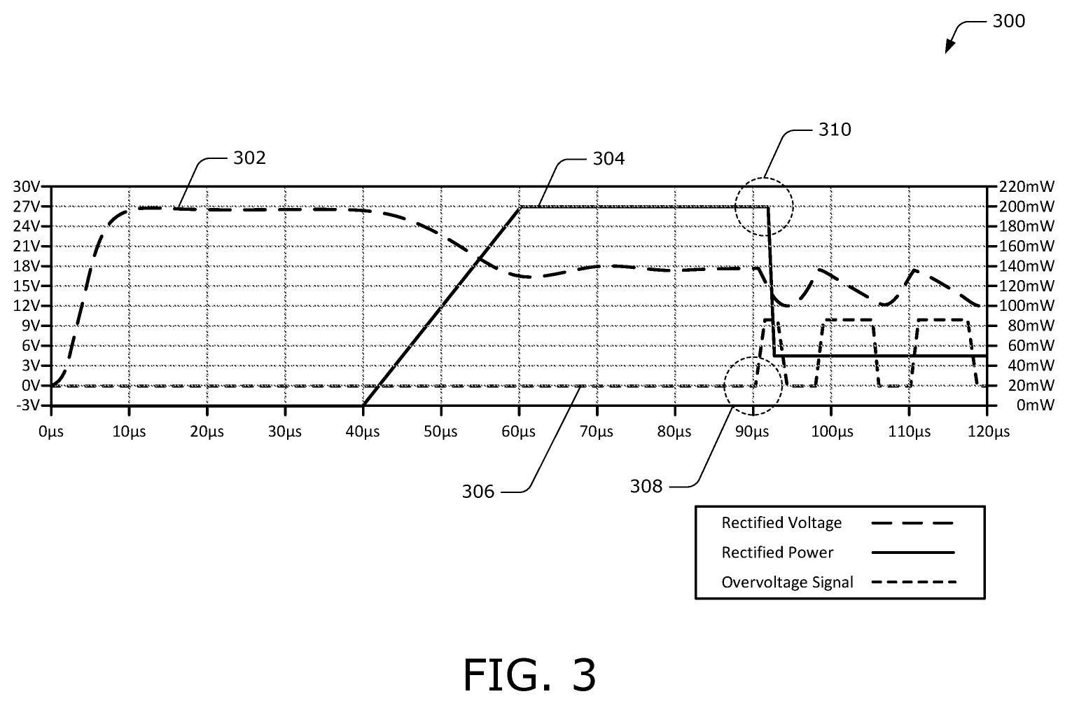

FIG. 3 illustrates an example signal diagram depicting indications of a rectified voltage, a rectified power, and an overvoltage protection control signal in a pre-overvoltage protection scenario in accordance with one or more aspects at 300.

In particular, the example signal diagram includes rectified voltage indication 302, rectified power indication 304, and overvoltage-protection control signal indication 306. In this example, the labels on the left side of the example diagram represent measured voltages, e.g., for the rectified voltage indication 302 and the overvoltage-protection control signal indication 306. In contrast, the labels on the right side of the example diagram represent power measurements, e.g., for the rectified power indication 304. The labels on the bottom of the example diagram represent time, such that the illustrated indications plot voltage and power over a time corresponding to the diagram, e.g., 0 to 120 microseconds (μs). It is to be appreciated that this diagram is to be used as an aid for understanding the described techniques. Accordingly, the described techniques, as implemented, may produce rectified voltages, rectified power, and overvoltage protection signals having different values (e.g., higher or lower voltages) and over different amounts of time than illustrated without departing from the spirit or scope of the described techniques.

In the context of FIG. 2, the rectified voltage indication 302 indicates rectified voltage measured over time at the output terminal 206 (Vrect). Further in the context of FIG. 2, the overvoltage-protection control signal indication 306 indicates voltage of a signal output by the Schmitt trigger 210 (Vovp), such that when the signal is high (e.g., approximately ten volts in the example diagram) the overvoltage protection clamp is engaged and when the signal is low (e.g., zero volts in the example diagram) the overvoltage protection clamp is disengaged. The rectified power indication 304 indicates an amount of power drawn over time by the PMIC 112.

The illustrated diagram corresponds to a scenario in which the wireless power transmitter 106 begins transmitting power at 0 microseconds, causing the rectified voltage to increase, as indicated by the rectified voltage indication 302. In this scenario, the PMIC 112 is allowed to draw power at 40 microseconds, causing the load to ramp up to its full, normal operational level at about 60 microseconds, e.g., 200 megawatts (mW). This causes the rectified voltage to drop and become substantially steady between about 80 and 90 microseconds. In this scenario, the overvoltage protection circuitry 208 is prevented from triggering until 90 microseconds. Additionally, the pre-overvoltage protection threshold is programmed into the overvoltage protection circuitry 208 (e.g., the Schmitt trigger 210) at 17 volts in this scenario. Thus, when the overvoltage protection circuitry 208 is allowed to trigger at 90 microseconds it does, as indicated at 308. Note that in implementation, a delay before triggering may be less than 90 microseconds or there may be no delay before the overvoltage protection circuitry 208 is allowed to trigger. This involves producing the overvoltage protection control signal, which is configured to engage the overvoltage protection clamp.

In connection with this, the PMIC 112 reduces its power draw, as indicated at 310, to a predefined level. In this scenario, the predefined level at which the PMIC 112 is configured to draw a reduced amount of power is about 50 megawatts. This reduced amount corresponds to a lesser amount of power than is drawn during normal operation. This keeps the rectified voltage from simply collapsing. Instead of collapsing, the rectified voltage oscillates between a defined overvoltage protection hysteresis, e.g., about 12 and 17 volts. In the context of FIG. 2, the overvoltage protection hysteresis is defined based on preprogramming the Schmitt trigger 210, such as to assert the overvoltage protection control signal when the rectified voltage reaches 17 volts and de-assert the signal when the rectified voltage drops to 12 volts.

In implementation, the wireless power transmitter 106 may transmit power at a level such that the voltage induced on the power receiving unit 116 generally steadies at a level that is less than in the illustrated example. In other words, the wireless power transmitter 106 may generally transmit power at a level such that the voltage induced on the power receiving unit 116 steadies below the pre-overvoltage protection threshold. Nonetheless, the described techniques may also enable the wireless power transmitter 106 to transmit power to implants in an ecosystem at a level (a maximal H-field) capable of inducing voltages at some power receiving units that are high enough to trigger pre-overvoltage protection and voltages at other power receiving units that are not high enough to trigger pre-overvoltage protection.

Techniques of a Power Receiving Unit for Charging while in Pre-Overvoltage Protection

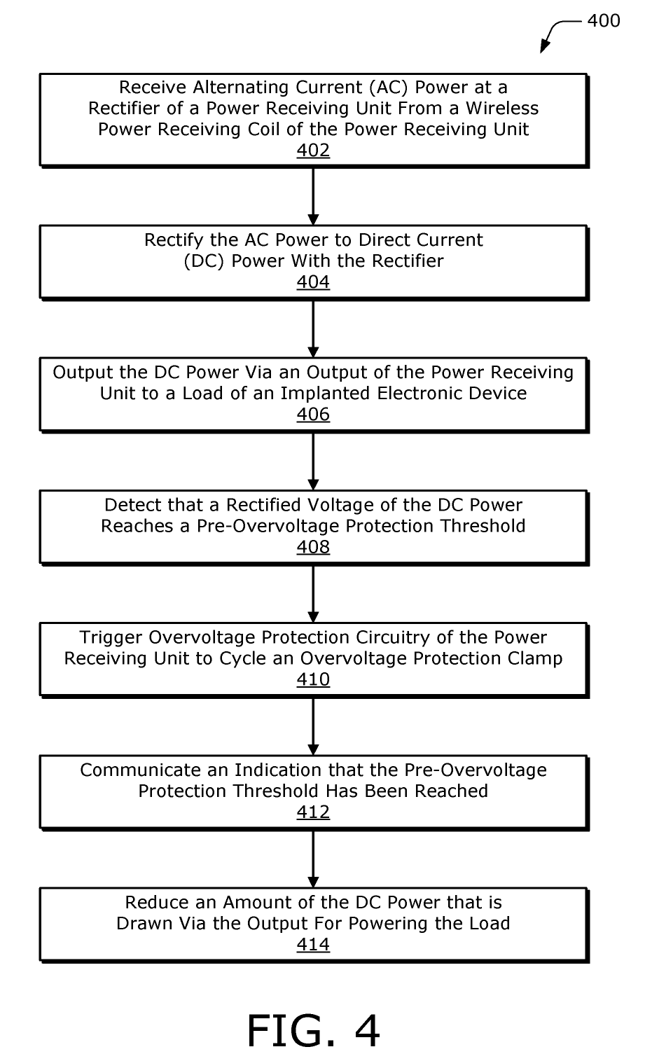

The following techniques of a power receiving unit for charging while in pre-overvoltage protection may be implemented using any of the previously described power receiving units of the example environment. The techniques may also involve powering an implant configured like the implanted electronic device 104 of the example environment or the system-on-chip described with reference to FIG. 7. Reference to entities, such as the power receiving unit 116 or the implanted electronic device 104, is made by example only and is not intended to limit the ways in which the techniques can be implemented. The techniques are described with reference to example methods illustrated in FIGS. 4-6. The example methods are depicted as respective sets of operations or acts that may be performed using the entities described herein and/or any suitable components which provide means for implementing one or more of the operations. The depicted sets of operations illustrate a few of the many ways in which the techniques may be implemented. As such, operations of a method may be repeated, combined, separated, omitted, performed in alternate orders, performed concurrently, or used in conjunction with another method or operations thereof.

FIG. 4 illustrates an example method 400 of charging with a power receiving unit while in pre-overvoltage protection for an implanted electronic device, including operations performed by the power receiving unit 116. In the following discussion, the power receiving unit 116 and other entities of the example environment 100 may provide means for implementing one or more of the operations described.

At 402, the method includes receiving alternating current (AC) power at a rectifier of a power receiving unit from a wireless power receiving coil of the power receiving unit. The power receiving unit may be included as part of an implanted electronic device. By way of example, consider FIG. 2, which illustrates an example configuration of the power receiving unit 116 in accordance with one or more aspects at 200. The power receiving unit 116 is incorporated as part of the implanted electronic device 104 depicted in FIG. 1. Further, the rectifier 204 receives AC power from the receiving coil 202, which is configured to couple to electromagnetic or magnetic fields transmitted by the wireless power transmitter 106. In general, the wireless power transmitter 106 transmits power wirelessly with a certain frequency or range of frequencies to supply the implanted electronic device 104 with power.

At 404, the method includes rectifying the AC power to direct current (DC) power with the rectifier. By way of example, the rectifier 204 rectifies the AC power received at 402 to DC power. At 406, the method includes outputting the DC power via an output of the power receiving unit to a load of an implanted electronic device. By way of example, the DC power produced at 404 is output via the output terminal 206. In accordance with the described aspects, the output terminal 206 is coupled to a load of the implanted electronic device 104, such as to the battery 114 or to a power receiver system such as the implant-specific circuitry of the implanted electronic device 104 via the PMIC 112.

At 408, the method includes detecting that a rectified voltage of the DC power reaches a pre-overvoltage protection threshold. By way of example, the overvoltage protection circuitry 208 detects that the rectified voltage at the output terminal 206 reaches a pre-overvoltage protection threshold. In general, the pre-overvoltage protection thresholds corresponds to a lower rectified voltage than an overvoltage protection threshold. At 410, the method includes triggering overvoltage protection circuitry of the power receiving unit to cycle an overvoltage protection clamp. By way of example, the overvoltage protection circuitry 208 is triggered to cyclically engage and disengage an overvoltage protection clamp (e.g., the NMOS transistor 212) to cause the rectified voltage to oscillate between a defined pre-overvoltage protection hysteresis. In one or more aspects, this involves cyclically shorting the power receiving unit 116 to the ground terminal 216.

In connection with cycling the overvoltage protection circuitry, at 412, the method includes communicating an indication that the pre-overvoltage protection threshold has been reached. By way of example, the power receiving unit 116 communicates an indication to the PMIC 112 indicating that the pre-overvoltage protection has been reached. Responsive to this communication, at 414, the method includes reducing an amount of DC power drawn via the output for powering the implant's load. By way of example, the PMIC 112 reduces the amount of power it draws from the power receiving unit 116 via the output terminal 206, e.g., reduces the amount of power drawn for charging the battery 114 and/or powering implant specific circuitry of the implanted electronic device 104.

Subsequently, the amount of DC power drawn from the power receiving unit can be increased responsive to detection that the rectified voltage of the DC power falls below a safe operating level for at least a period of time. By way of example, the PMIC 112 increases the amount of power it draws from the power receiving unit 116 via the output terminal 206. In particular, the PMIC 112 increases the power drawn when the rectified voltage of the DC power falls below a predetermined safe operating level for a predetermined amount of time.

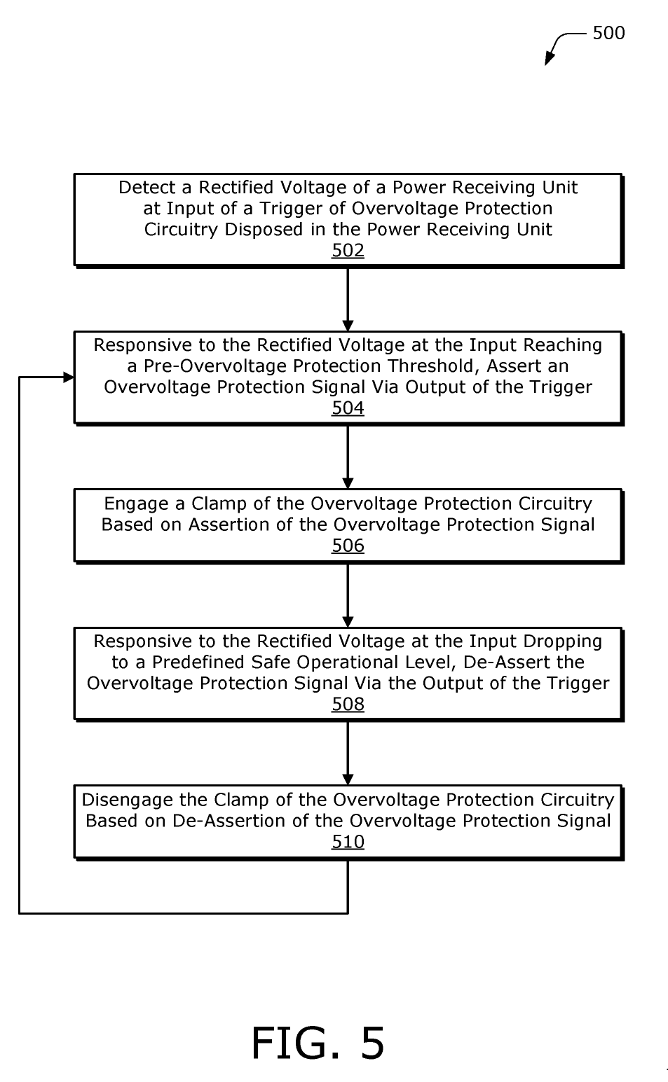

FIG. 5 illustrates an example method 500 of cycling overvoltage protection circuitry of a power receiving unit to provide pre-overvoltage protection and simultaneous charging for an implanted electronic device. In the following discussion, the power receiving unit 116 and other entities of the example environment 100 may provide means for implementing one or more of the operations described.

At 502, the method includes detecting a rectified voltage of a power receiving unit at input of a trigger of overvoltage protection circuitry. In accordance with the principles discussed herein, the overvoltage protection circuitry is disposed in the power receiving unit. In the context of FIG. 2, the Schmitt trigger 210 detects at its input the rectified voltage (Vrect) of the power receiving unit 116. In one or more aspects, detecting the rectified voltage corresponds to measuring the voltage, while in other aspects detecting the rectified voltage involves simply detecting whether a voltage is or is not sufficient to trigger some response.

Responsive to detecting that the rectified voltage at the input reaches a pre-overvoltage protection threshold, at 504, the method includes asserting an overvoltage protection signal via output of the trigger. By way of example, the rectified voltage detected at 502 reaches a pre-overvoltage protection threshold preprogrammed into the Schmitt trigger 210. Responsive to this, the Schmitt trigger 210 asserts via its output the overvoltage protection signal (Vovp).

At 506, the method includes engaging a clamp of the overvoltage protection circuitry based on assertion of the overvoltage protection signal. By way of example, the NMOS transistor 212 activates based on the overvoltage protection signal to short the power receiving unit 116 to the ground terminal 216. In connection with reducing the power drawn by the PMIC 112, as discussed above, this may be effective to reduce the voltage induced on the power receiving unit 116. In particular, the voltage may be reduced without collapsing too quickly to a level where the system is unable to recover without resetting.

Responsive to the rectified voltage at the input dropping to a predefined safe operational level, at 508, the method includes, de-asserting the overvoltage protection signal via the output of the trigger. By way of example, the rectified voltage detected at the input of the Schmitt trigger 210 drops to a predefined safe operational level, which is also preprogrammed into the Schmitt trigger 210. Responsive to this, the Schmitt trigger 210 de-asserts the overvoltage protection signal (Vovp).

At 510, the method includes disengaging the clamp of the overvoltage protection circuitry based on de-assertion of the overvoltage protection signal. By way of example, the NMOS transistor 212 deactivates based on de-assertion of the overvoltage protection signal. In other words, the NMOS transistor 212 stops shorting the power receiving unit 116 to the ground terminal 216. As a result of this, however, the voltage induced on the power receiving unit 116 may again increase. Indeed, the voltage may increase again to the pre-overvoltage protection threshold. When this happens, the method continues at 504. By asserting and de-asserting the overvoltage protection signal, and thus engaging and disengaging the overvoltage protection clamp, the voltage at the power receiving unit may oscillate between a defined overvoltage protection hysteresis.

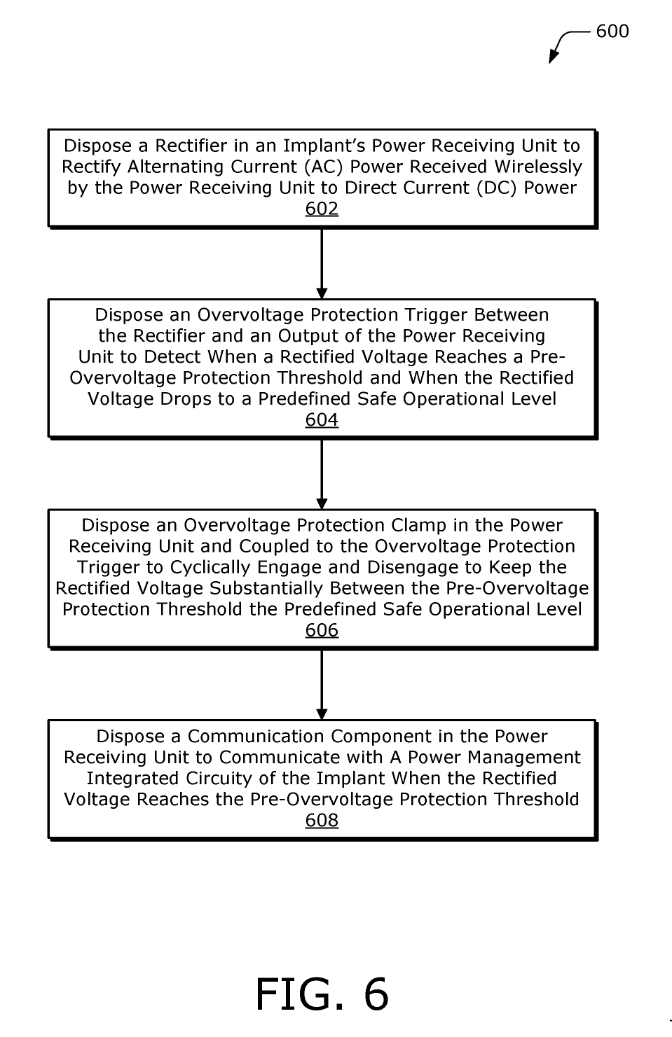

FIG. 6 illustrates an example method 600 of configuring an implanted electronic device to provide a power receiving unit for charging while in pre-overvoltage protection. In the following discussion, the power receiving unit 116 and other entities of example environment 100 may provide means for implementing one or more of the operations described.

At 602, the method includes disposing a rectifier in an implant's power receiving unit to rectify alternating current (AC) power received wirelessly by the power receiving unit to direct current (DC) power. By way of example, consider again FIG. 2, which illustrates an example power receiving unit in accordance with one or more aspects generally at 200. In aspects, the example configuration of FIG. 2 corresponds to the power receiving unit 116 of the implanted electronic device 104. In this example, the rectifier 204 is disposed in the power receiving unit 116 to rectify AC power received wirelessly by the receiving coil 202.

At 604, the method includes disposing an overvoltage protection trigger between the rectifier and an output of the power receiving unit. In accordance with the principles described herein, the overvoltage protection trigger is configured to detect when a rectified voltage of the power receiving unit reaches a pre-overvoltage protection threshold and subsequently drops to a predefined safe operational level. By way of example, the Schmitt trigger 210 is disposed in the power receiving unit 116 between the rectifier 204 and the output terminal 206. In this example, the Schmitt trigger 210 is disposed to detect when the rectified voltage (Vrect) of the power receiving unit 116 reaches a pre-overvoltage protection level and drops to a predefined safe operational level. In one or more aspects, the overvoltage protection trigger measures the voltage induced at the power receiving unit.

At 606, the method includes disposing an overvoltage protection clamp in the power receiving unit and coupled to the overvoltage protection trigger. In accordance with the principles discussed herein, the overvoltage protection clamp is configured to cyclically engage and disengage to keep the rectified voltage substantially between the pre-overvoltage protection threshold and the predefined safe operational level. By way of example, the NMOS transistor 212 is disposed in the power receiving unit 116 and coupled to the Schmitt trigger 210. In this example, the NMOS transistor 212 cyclically engages and disengages based on the signal output by the Schmitt trigger 210 to keep the rectified voltage of the power receiving unit 116 substantially between the pre-overvoltage protection threshold and the predefined safe operational level.

At 608, the method includes disposing a communication component in the power receiving unit. In accordance with the principles discussed herein, the communication component is configured to communicate with a power management integrated circuit when the rectified voltage reaches the pre-overvoltage protection threshold. By way of example, a communication component is integrated with the power receiving unit 116 to communicate with the PMIC 112 when the rectified voltage reaches the pre-overvoltage protection threshold. The communication component may be configured in a variety of different ways as discussed above. In accordance with one or more aspects, the communication component or a different communication component is disposed in the implanted electronic device 104 to communicate with the wireless power transmitter 106. In this way, the wireless power transmitter 106 may be notified when the power receiving unit 116 triggers pre-overvoltage protection and adjust the wireless power transmitted accordingly.

The described aspects provide power to the implanted electronic device 104 in a form for which its components are designed. This allows the implanted electronic device 104 to carry out the functionality for which it was designed using the wireless power received from the wireless power transmitter 106.

### System-on-Chip

FIG. 7 illustrates an example system-on-chip 700, which includes components capable of implementing aspects of a power receiving unit for charging while in pre-overvoltage protection. The system-on-chip 700 may be implemented as, or in, any suitable electronic device in a body, such as implants to release metered doses of medication, implants to stimulate bodily tissue (e.g., nerves), implants to monitor specific biochemical conditions, and so on, or any other device that may utilize power transmitted wirelessly from a transmitter outside the body.

The system-on-chip 700 may be integrated with a microprocessor, storage media, I/O logic, data interfaces, logic gates, a transmitter, a receiver, circuitry, firmware, software, or combinations thereof to provide communicative or processing functionalities. The system-on-chip 700 may include a data bus (e.g., cross bar or interconnect fabric) enabling communication between the various components of the system-on-chip. In some aspects, components of the system-on-chip 700 may interact via the data bus to implement aspects of a power receiving unit for charging while in pre-overvoltage protection.

In this particular example, the system-on-chip 700 includes processor cores 702, system memory 704, and cache memory 706. The system memory 704 or the cache memory 706 may include any suitable type of memory, such as volatile memory (e.g., DRAM), non-volatile memory (e.g., Flash), and the like. The system memory 704 and the cache memory 706 are implemented as a storage medium, and thus do not include transitory propagating signals or carrier waves. The system memory 704 can store data and processor-executable instructions of the system-on-chip 700, such as operating system 708 and other applications. The processor cores 702 execute the operating system 708 and other applications from the system memory 704 to implement functions of the system-on-chip 700, the data of which may be stored to the cache memory 706 for future access. The system-on-chip 700 may also include I/O logic 710, which can be configured to provide a variety of I/O ports or data interfaces for inter-chip or off-chip communication.

The system-on-chip 700 also includes the power receiving unit 116 and implant-specific circuitry 712, which may be embodied separately or combined with other components described herein. For example, the power receiving unit 116 may be integral with the PMIC 112 or the battery 114 as described with reference to FIG. 1. The implant-specific circuitry 712 can be implemented to carry out the functionality specific to an implant.

The implant-specific circuitry 712 may also be integrated with other components of the system-on-chip 700, such as the cache memory 706, a memory controller of the system-on-chip 700, or any other signal processing, modulating/demodulating, or condition sections within the system-on-chip 700. The implant-specific circuitry 712 and other components of the system-on-chip 700 may be implemented as hardware, fixed-logic circuitry, firmware, or a combination thereof that is implemented in association with the I/O logic 710 or other signal processing circuitry of the system-on-chip 700.

### Wireless Power Transfer System

FIG. 8 illustrates an example wireless power transfer system 800, which includes components capable of implementing aspects of a power receiving unit for charging while in pre-overvoltage protection. The system 800 includes a transmitter 802 and a receiver 804. The transmitter 802 may include transmit circuitry 806 having an oscillator 808, a driver circuit 810, and a front-end circuit 812. The oscillator 808 may be configured to generate an oscillator signal at a desired frequency that may adjust in response to a frequency control signal 814. The oscillator 808 may provide the oscillator signal to the driver circuit 810. The driver circuit 810 may be configured to drive the power transmitting element 816 at, for example, a resonant frequency of the power transmitting element 816 based on an input voltage signal (VD) 818. The driver circuit 810 may be a switching amplifier configured to receive a square wave from the oscillator 808 and output a sine wave.

The front-end circuit 812 may include a filter circuit configured to filter out harmonics or other unwanted frequencies. The front-end circuit 812 may include a matching circuit configured to match the impedance of the transmitter 802 to the impedance of the power transmitting element 816. The front-end circuit 812 may include also a tuning circuit to create a resonant circuit with the power transmitting element 816. As a result of driving the power transmitting element 816, the power transmitting element 816 may generate a wireless field 820 to wirelessly output power at a level sufficient for charging a battery 822, or otherwise powering a load.

The transmitter 802 may further include a controller 824 operably coupled to the transmit circuitry 806 and configured to control one or more aspects of the transmit circuitry 806, or accomplish other operations relevant to managing the wireless transfer and charging with a power receiving unit while in pre-overvoltage protection. The controller 824 may be a micro-controller or a processor. The controller 824 may be implemented as an application-specific integrated circuit (ASIC). The controller 824 may be operably connected, directly or indirectly, to each component of the transmit circuitry 806. The controller 824 may be further configured to receive information from each of the components of the transmit circuitry 806 and perform calculations based on the received information. The controller 824 may be configured to generate control signals (e.g., the control signal 814) for each of the components that may adjust the operation of that component. As such, the controller 824 may be configured to adjust or manage the power transfer for charging with a power receiving unit while in pre-overvoltage protection based on a result of the operations it performs. The transmitter 802 may further include a memory (not shown) configured to store data, for example, such as instructions for causing the controller 824 to perform particular functions, such as those related to management of wireless power transfer.

The receiver 804 may include receive circuitry 826 having a front-end circuit 828 and a rectifier circuit 830. The front-end circuit 828 may include matching circuitry configured to match the impedance of the receive circuitry 826 to the impedance of the power receiving element 832. The front-end circuit 828 may further include a tuning circuit to create a resonant circuit with the power receiving element 832. The rectifier circuit 830 may generate a DC power output from an AC power input to charge the battery 822, as shown in FIG. 8, or provide power to some other load, such as directly to implant-specific circuitry in scenarios without batteries. The receiver 804 and the transmitter 802 may additionally communicate on a separate communication channel 834, e.g., Bluetooth™, ZigBee™, and cellular. The receiver 804 and the transmitter 802 may alternatively communicate via in-band signaling using characteristics of the wireless field 820.

Further, the receiver 804 may be configured to determine whether an amount of power transmitted by the transmitter 802 and received by the receiver 804 is appropriate for charging the battery 822 or powering a load. In certain embodiments, the transmitter 802 may be configured to generate a predominantly non-radiative field with a direct field coupling coefficient (k) for providing energy transfer. The receiver 804 may directly couple to the wireless field 820 and may generate an output power for storing or consumption by the battery 822 (or load), coupled to the output of the receive circuitry 826.

The receiver 804 may further include a controller 836 configured similarly to the transmit controller 824 as described above for one or more wireless power management aspects of the receiver 804. The receiver 804 may further include a memory (not shown) configured to store data, such as instructions for causing the controller 836 to perform particular functions, such as those related to management of wireless power transfer and charging with a power receiving unit while in pre-overvoltage protection. The transmitter 802 and receiver 804 may be separated by a distance and configured according to a mutual resonant relationship to minimize transmission losses between the transmitter 802 and the receiver 804.

The power transmitting element 816 and the power receiving element 832 may correspond to or be included as part of, respectively, the wireless power transmitter 106 and the power receiving unit 116 that utilize the power receiving unit for charging while in pre-overvoltage protection described herein.

Although subject matter has been described in language specific to structural features or methodological operations, it is to be understood that the subject matter defined in the appended claims is not necessarily limited to the specific features or operations described above, including not necessarily being limited to the organizations in which features are arranged or the orders in which operations are performed.

What is claimed is:

1. An apparatus for initiating reduced operation before resorting to overvoltage protection in connection with receiving power wirelessly from a wireless power transmitter, the apparatus comprising:
a power receiving unit configured to receive the power wirelessly from the wireless power transmitter, detect a voltage induced at the power receiving unit, and trigger pre-overvoltage protection when the detected voltage reaches a pre-overvoltage protection threshold; and
a power management integrated circuit (PMIC) coupled to the power receiving unit that is configured to draw power for operation from the power receiving unit, obtain an indication from the power receiving unit when the detected voltage reaches the pre-overvoltage protection threshold, and draw the power from the power receiving unit at a predefined level based on the obtained indication.

2. The apparatus as recited in claim 1, wherein the predefined level is a lesser amount of the power than is drawn during normal operation of the apparatus.

3. The apparatus as recited in claim 1, wherein the power receiving unit is further configured to trigger the overvoltage protection when the detected voltage reaches an overvoltage protection threshold.

4. The apparatus as recited in claim 3, wherein the PMIC is further configured to discontinue drawing power from the power receiving unit when the detected voltage reaches the overvoltage protection threshold.

5. The apparatus as recited in claim 4, wherein the pre-overvoltage protection threshold corresponds to a lower voltage than the overvoltage protection threshold.

6. The apparatus as recited in claim 1, wherein the PMIC is coupled to a battery or power receiver system and is further configured to supply the battery or power receiver system with the power drawn at the predefined level when the pre-overvoltage protection threshold is reached.

7. The apparatus as recited in claim 1, wherein the power receiving unit comprises a rectifier configured to rectify alternating current (AC) power received by the power receiving unit to direct current (DC) power.

8. The apparatus as recited in claim 7, wherein the detected voltage is a rectified voltage of the DC power.

9. The apparatus as recited in claim 8, wherein the power receiving unit further comprises:
an overvoltage protection trigger configured to assert an overvoltage protection signal when the rectified voltage reaches the pre-overvoltage protection threshold; and
an overvoltage protection clamp configured to engage responsive to assertion of the overvoltage protection signal to short the power receiving unit to ground.

10. The apparatus as recited in claim 9, wherein:
the overvoltage protection trigger is further configured to de-assert the overvoltage protection signal when the rectified voltage drops to a predefined safe operational level due to engagement of the overvoltage protection clamp; and
the overvoltage protection clamp is further configured to disengage responsive to de-assertion of the overvoltage protection signal to cease shorting the power receiving unit to ground.

11. The apparatus as recited in claim 10, wherein:
the overvoltage protection trigger comprises a Schmitt trigger disposed between the rectifier and an output of the power receiving unit, the Schmitt trigger programmed to assert the overvoltage protection signal based on the pre-overvoltage protection threshold and de-assert the overvoltage protection signal based on the predefined safe operational level; and
the overvoltage protection clamp comprises a field-effect transistor coupled to the Schmitt trigger.

12. The apparatus as recited in claim 1, wherein the power receiving unit is further configured to provide the indication to the PMIC when the detected voltage reaches the pre-overvoltage protection threshold.

13. The apparatus as recited in claim 1, further comprising a communication component configured to communicate with the wireless power transmitter in conjunction with the pre-overvoltage protection to indicate that the pre-overvoltage protection threshold is reached.

14. The apparatus as recited in claim 1, wherein the apparatus is an implant intended for use within a body and further comprises implant-specific circuitry configured to perform one or more implant functions using the power drawn by the PMIC.

15. The apparatus as recited in claim 14, wherein the wireless power transmitter is further configured to transmit the power from outside the body.

16. The apparatus as recited in claim 14, wherein the wireless power transmitter is configured to wirelessly transmit the power to multiple implants in the body.

17. A method for providing pre-overvoltage protection for an electronic device before resorting to overvoltage protection, the method comprising:
receiving alternating current (AC) power at a rectifier of a power receiving unit of the electronic device, the AC power generated based on wireless power received at the power receiving unit from a wireless power transmitter;
rectifying the AC power to direct current (DC) power with the rectifier, the DC power being supplied to power a load of the electronic device; and
responsive to detecting that a rectified voltage of the DC power reaches a pre-overvoltage protection threshold:
triggering overvoltage protection circuitry of the power receiving unit to cycle an overvoltage protection clamp; and
reducing an amount of the DC power that is supplied to the load of the electronic device.

18. The method as recited in claim 17, wherein cycling the overvoltage protection clamp includes engaging and disengaging the overvoltage protection clamp so that the rectified voltage oscillates between a defined overvoltage protection hysteresis.

19. The method as recited in claim 18, wherein the overvoltage protection hysteresis is defined based on the pre-overvoltage protection threshold and a predefined safe operational level that corresponds to a lower rectified voltage than the pre-overvoltage protection threshold.

20. The method as recited in claim 17, wherein cycling the overvoltage protection clamp includes:
engaging the overvoltage protection clamp to short the power receiving unit to ground responsive to detecting that the rectified voltage reaches the pre-overvoltage protection threshold; and
disengaging the overvoltage protection clamp to cease shorting the power receiving unit to ground responsive to detecting that the rectified voltage drops to a predefined safe operational level that corresponds to a lower rectified voltage than the pre-overvoltage protection threshold.

21. The method as recited in claim 17, further comprising communicating an indication to a power management integrated circuit (PMIC) configured to manage the amount of DC power supplied to the load, the indication indicating that the pre-overvoltage protection threshold has been reached, and the PMIC reducing the amount of DC power supplied to the load based on the indication.

22. The method as recited in claim 17, further comprising coupling a receiving coil of the power receiving unit to a wireless field generated by the wireless power transmitter to receive the wireless power.

23. The method as recited in claim 17, wherein the electronic device comprises an implant inserted in a body and the wireless power transmitter is outside the body.

24. An apparatus comprising:
implant-specific circuitry configured to perform one or more implant functions in a body; and
a power receiving unit including:
a power receiving coil configured to couple to a wireless field generated by a wireless power transmitter and receive wireless power based on the coupling;
a rectifier configured to rectify alternating current (AC) power from the power receiving coil to direct current (DC) power;
an output terminal configured to output the DC power for operation of the implant-specific circuitry; and
overvoltage protection circuitry disposed in the power receiving unit between the rectifier and the output terminal, the overvoltage protection circuitry configured to detect that a rectified voltage of the DC power reaches a pre-overvoltage protection threshold and trigger pre-overvoltage protection responsive to detection.

25. The apparatus as recited in claim 24, wherein the power receiving unit further comprises a communication component configured to communicate an indication to a power management integrated circuit (PMIC) that manages the DC power used for the operation of the implant-specific circuitry, the indication indicating to the PMIC to reduce an amount of the DC power used.

26. The apparatus as recited in claim 25, wherein the PMIC is configured to reduce the amount of DC power used to a level that is preprogrammed into the PMIC.

27. The apparatus as recited in claim 24, wherein the overvoltage protection circuitry includes:
an overvoltage protection trigger configured to detect that the rectified voltage of the DC power reaches the pre-overvoltage protection threshold and, in response, the overvoltage protection trigger further configured to cyclically assert and de-assert an overvoltage protection signal based on the rectified voltage; and
an overvoltage protection clamp configured to engage responsive to assertion of the overvoltage protection signal to lower the rectified voltage, the overvoltage protection clamp further configured to disengage based on de-assertion of the overvoltage protection signal.

28. An apparatus for providing pre-overvoltage protection in connection with receiving power wirelessly before resorting to overvoltage protection, the apparatus comprising:
a rectification means for rectifying alternating current (AC) power received to direct current (DC) power;
an overvoltage protection clamping means for cyclically clamping the DC power so that a rectified voltage of the DC power oscillates between a defined pre-overvoltage protection hysteresis, the overvoltage protection clamping means cyclically clamping the DC power responsive to the pre-overvoltage protection being triggered, and the DC power output from the rectification means being usable by the apparatus; and
a power management means for reducing an amount of the DC power used by the apparatus while the overvoltage protection clamping means cyclically clamps the DC power.

29. The apparatus as recited in claim 28, further comprising a rectified voltage detection means for detecting that the rectified voltage of the DC power reaches a pre-overvoltage protection threshold and triggering the pre-overvoltage protection.

30. The apparatus as recited in claim 28, further comprising communication means for communicating at least one of:
an indication to the power management means that the pre-overvoltage protection is triggered, the indication indicating to reduce the amount of DC power used by the apparatus; or
a different indication to a wireless power transmitting means that transmits the power wirelessly, the different indication indicating to adjust the power being transmitted wirelessly in accordance with the pre-overvoltage protection.
